(19) United States
(12) Patent Application Publication
(10) Pub. No.: US 2014/0063340 A1
(43) Pub. Date: Mar. 6, 2014

(54) VIDEO PROCESSING DEVICE WITH BUFFER FEEDBACK AND METHODS FOR USE THEREWITH

(71) Applicant: Paul D. Ducharme, Richmond Hill (CA)

(72) Inventor: Paul D. Ducharme, Richmond Hill (CA)

(73) Assignee: VIXS SYSTEMS, INC., Toronto (CA)

(21) Appl. No.: 13/604,318

(22) Filed: Sep. 5, 2012

(51) Int. Cl. H04N 7/01

(52) U.S. Cl. 348/441; 348/E07.003

(57) ABSTRACT

A video processing device includes a rate controller coupled to receive non-real time audio/video (A/V) data and buffer state feedback data from an input/output (I/O) device. The rate controller generates rate controlled non-real time A/V data from the non-real time A/V data and in response to the buffer state feedback data. A multiplexor multiplexes the rate controlled non-real time A/V data with real-time A/V data to generates multiplexed A/V data for input to the I/O device.

### TECHNICAL FIELD OF THE INVENTION

The present invention relates to processing and distribution of media content such as audio/video content.

### DESCRIPTION OF RELATED ART

In the audio/video (A/V) content delivery systems it is common for third party devices to be used to receive and process content (for example to decrypt/alter/re-encrypt the content) which originates from multiple real time and non-real time sources. It is often desirable to use the same physical interfaces to send and receive content to/from the device. For example, detachable security elements (such as cable cards) or custom third party devices can be attached to a host system such as a set-top box, television, server or other video processing component to process both isochronous and asynchronous information via the same interface. The content sent to and received from the 3^{rd} party device may not be the same i.e. the device consume content and may originate or alter content.

Problems can result when both real time (isochronous) and non-real time (asynchronous) information must be processed within a separate component. In particular, content from various sources may include bursts and often there is no temporal relation between the multiple content sources. These problems are exacerbated by differing isochronous bandwidth requirements associated with CBR/VBR streams or data services, specific timing requirements of asynchronous streams, personal video recorder (PVR) playback from disk, burst playback including fast forward, rewind, pause, skip ahead and other trick mode features of either a PVR or playback of streaming A/V content. This can result in too much or too little data being provided to the third party device resulting in buffer overflows or underutilization of interface bandwidth. Prediction algorithms that attempt to control the data processed by the third party device can be complex and error prone.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a schematic block diagram representation of a video system 175 in accordance with an embodiment of the present invention.

FIG. 2 presents a schematic block diagram representation of a video system 175′ in accordance with an embodiment of the present invention.

FIG. 3 presents a schematic block diagram representation of a rate controller 110 or 110′ in accordance with an embodiment of the present invention.

FIG. 4 presents a schematic block diagram representation of a video storage system 179 in accordance with an embodiment of the present invention.

FIG. 5 presents a schematic block diagram representation of a video distribution system 375 in accordance with an embodiment of the present invention.

FIG. 6 presents a flowchart representation of a method in accordance with an embodiment of the present invention.

### DETAILED DESCRIPTION OF THE INVENTION INCLUDING THE PRESENTLY PREFERRED EMBODIMENTS

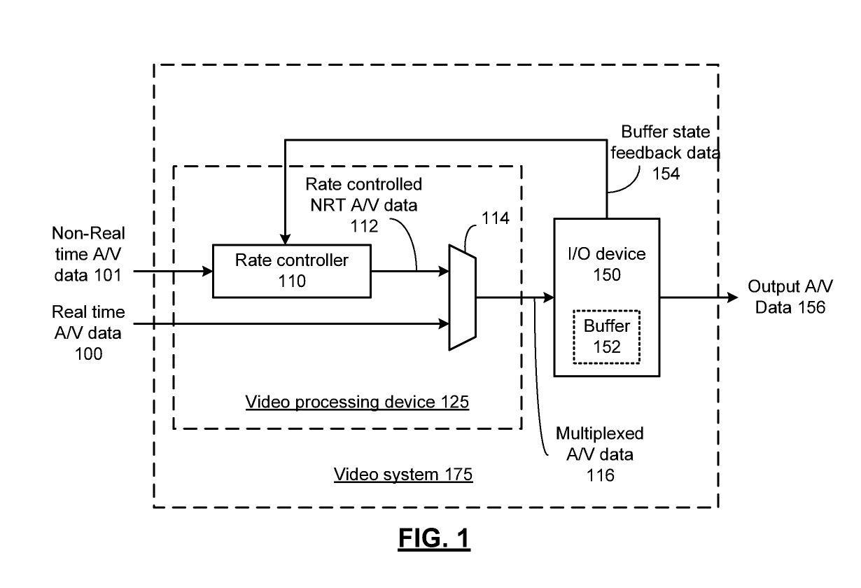

FIG. 1 presents a schematic block diagram representation of a video system 175 in accordance with an embodiment of the present invention. In particular a video system is presented that includes video processing device 125, and input/output (I/O) device 150. A video processing device 125 includes a rate controller 110 coupled to receive non-real time audio/video (A/V) data 101 and buffer state feedback data 154 from the input/output device 150. The rate controller 110 generates rate controlled non-real time A/V data 112 from the non-real time A/V data 101 and in response to the buffer state feedback data 154. A multiplexor 114 multiplexes the rate controlled non-real time A/V data 112 with real-time A/V data 100 to generate multiplexed A/V data 116 for input to the I/O device 150. The non-real-time A/V data 101 can include audio files, video files and/or other media content that is transported in an asynchronous or other non-real time format. The real time A/V data 100 includes streaming audio, streaming video and/or other media content that is transported in an isochronous or other real time or pseudo real time format.

The I/O device 150 includes at least one buffer 152 for buffering the multiplexed A/V data 116 in conjunction with processing of the data into output A/V data 156. Such processing can include encryption, decryption, transcryption, encoding, decoding, transcoding, transrating or other processing of the multiplexed A/V data 116 into output A/V data 156. The buffer state feedback data 154 indicates a fullness of the buffer or buffers 152. The I/O device 150 can be a third party device to be used to receive and process content (for example, to encode, decode or transcode, or to decrypt/alter/re-encrypt the content) which originates from multiple real time and non-real time sources. For example, the I/O device 150 can be a detachable security element (such as a cable card) or custom third party device that is attached to video system 175 such as a set-top box, television, server or other video processing component to process both isochronous and asynchronous information via the same interface.

In operation, the rate controller provides a rate control mechanism that responds to buffer levels within the I/O device 150 which makes the decisions to adjust the rates of the non-real-time A/V data 101 to form a rate-controlled non-real time A/V data 112. The rate controller 110 controls the rate of the asynchronous stream to allow the I/O device 150 to serve the real-time A/V data 100. When the I/O device 150 has sufficient buffer space available, asynchronous content is permitted to be included in the multiplexed A/V data 116 that is sent to the I/O device 150. In this way the interface utilization may be maximized without there being a risk of overflowing buffer or buffers 152 within the I/O device 150. The buffer state feedback data 154 from I/O device 150 allows the rate controller 110 to be aware of the actual buffer availability within the I/O device without the need for forecasting or prediction that may be unreliable. The rate controller 110 can further analyze the incoming non-real time A/V data 101 to make decisions as to when and at what rate and the non-real time A/V data 101 will be multiplexed with the real-time A/V data 100.

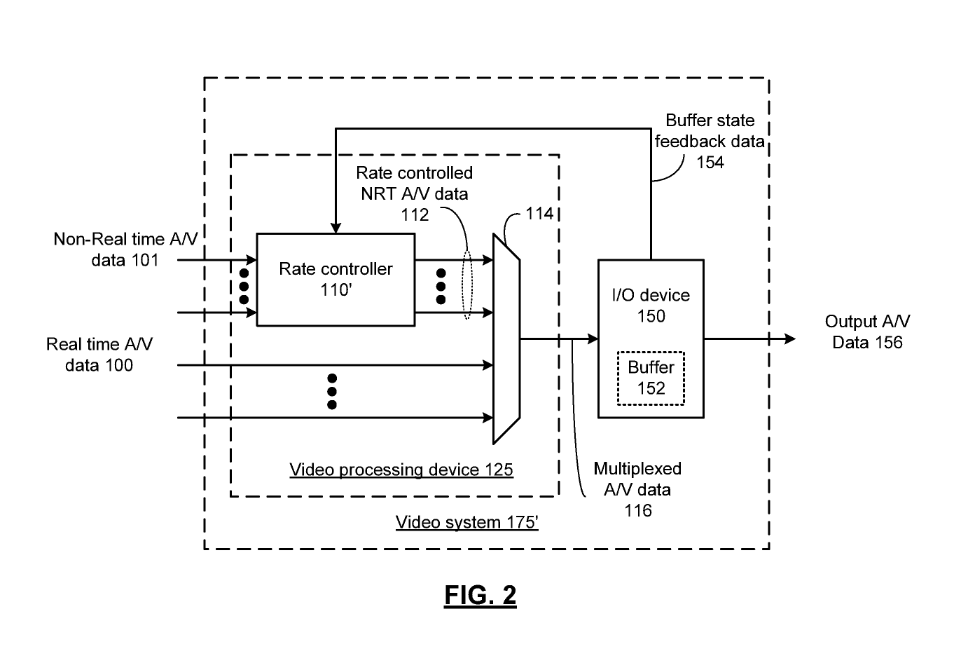

Further details including several optional functions and features are described in conjunction with FIGS. 2-6 that follow.

FIG. 2 presents a schematic block diagram representation of a video system 175′ in accordance with an embodiment of the present invention. In particular a system that is similar to the video processing system 175 of FIG. 1 is presented that includes similar elements that are referred to by common reference numerals.

In this embodiment, rate controller 110′ operates in a similar fashion to rate controller 110 but controls the rate of a plurality of non-real time A/V data streams 101 carrying, for example, multiple A/V programs or other content. The rate controller 110′ can also analyze the incoming non-real time A/V data 101 to make decisions as to when, and at what rate, the non-real time A/V data 101 will be multiplexed with the one or more streams of real-time A/V data 100 and further which non-real time A/V data 101 will be multiplexed and sent to the I/O device 150.

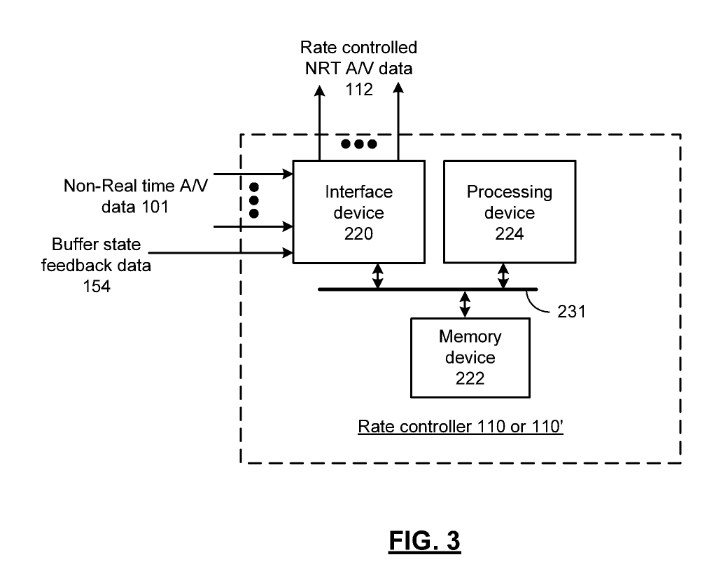

FIG. 3 presents a schematic block diagram representation of a rate controller 110 or 110′ in accordance with an embodiment of the present invention. In particular an implementation of rate controller 110 or 110′ is shown that includes interface device 220, memory device 222, processing device 224 and bus 231. The interface device 220, receives the non-real time A/V data 101 and buffer feedback data 154 and rate controlled non-real time A/V data 112 in conjunction with memory device 222 and processing device 224.

In an embodiment of the present invention, the processing device 224 and the interface device 220 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 222. Memory module 222 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is shown that employs a single bus 231, alternative architectures using direct connectivity between one or more modules and/or additional buses can likewise be implemented in accordance with the present invention.

In operation, the memory device 222 buffers the incoming non-real-time A/V data 101 and the rate controller 110 or 110′ adjusts a rate of one or more streams of rate controlled non-real time A/V data 112 in response to the buffer state feedback data 154. In an embodiment, the rate controller 110 or 110′ lowers a rate of the rate controlled non-real time A/V data 112 when the buffer state feedback 154 indicates the fullness of the buffer is above a first fullness threshold indicating that the buffer or buffer 152 could be becoming too full to process the real-time A/V data 100 without interruption. Further, the rate controller 110 or 110′ can lower a rate of the rate controlled non-real time A/V data 112 to zero when the buffer state feedback 154 indicates the fullness of the buffer is above a second fullness threshold that indicates that the buffer 152 is at or nearing its capacity.

In another embodiment, the processing device operates via a feedback control algorithm to adjust the data rate of non-real-time A/V data 112 to control the buffer fullness indicated by buffer state feedback 154 to an optimum, median or other nominal value. Such a feedback control algorithm can include a linear quadratic regulator, proportional, integral derivative (PID) controller or other feedback control algorithm implemented via a hardware specific configuration of processing device 224 or via software stored in memory device 222.

As discussed in conjunction with FIGS. 1 and 2, the rate controller 110 or 110′ can also analyze the incoming non-real time A/V data 101 to make decisions as to when, and at what rate, the non-real time A/V data 101 will be multiplexed with the one or more streams of real-time A/V data 100 and further which non-real time A/V data 101 will be multiplexed and sent to the I/O device 150. In this configuration, the memory device 222 can include a look-up table that generates the rates of the rate controlled non-real time data 112 in response to input values of the buffer state feedback data 154 and further in response to characteristics extracted by analysis by the processing device 224 of the incoming non-real time A/V data 101.

FIG. 4 presents a block diagram representation of a video storage system 179 in accordance with an embodiment of the present invention. In particular, device 11 is a set top box with built-in digital video recorder functionality, a stand alone digital video recorder, a DVD recorder/player or other device that includes video system 175 and that processes non-real-time A/V data 101 and real-time A/V data 100 for display on video display device such as television 12.

While these particular devices are illustrated, video storage system 179 can include a hard drive, flash memory device, computer, DVD burner, or any other device that is capable of implementing the video system 175 in accordance with the methods and systems described in conjunction with the features and functions of the present invention as described herein.

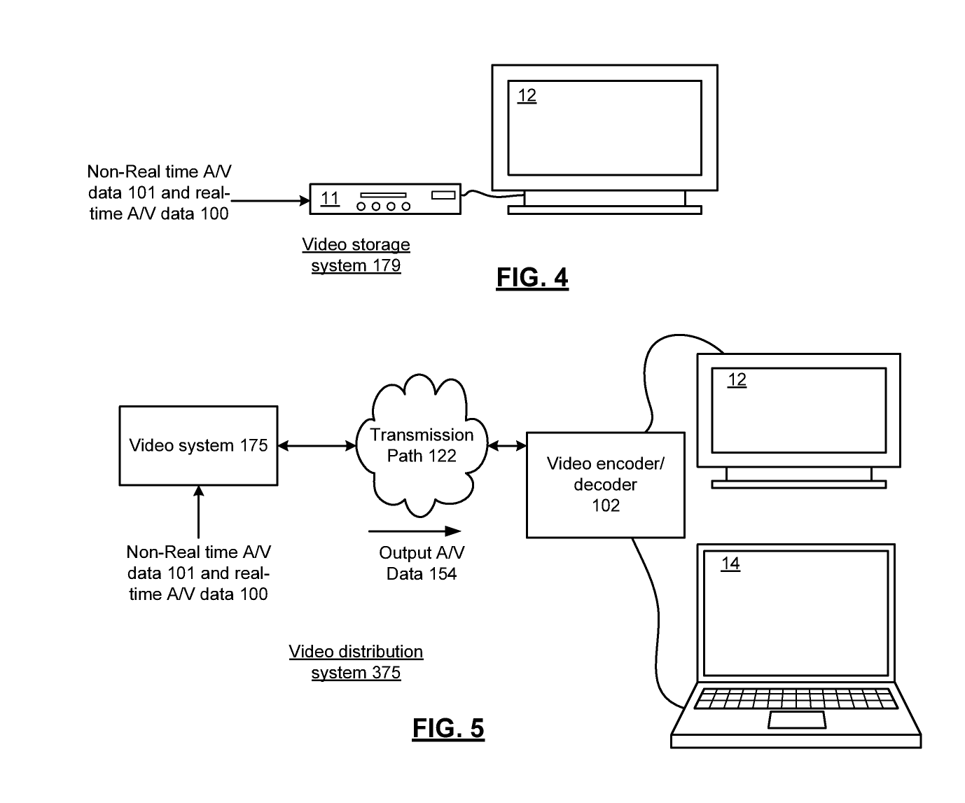

FIG. 5 presents a block diagram representation of a video distribution system 375 in accordance with an embodiment of the present invention. In particular, output A/V data 154 generated by a video system 175 is transmitted via a transmission path 122 to a second video encoder/decoder 102 that generates a processed video signal for display on a display device such as television 12, computer 14 or other display device. While shown as being separate from the television 12 or computer 14, the video encoder/decoder 102 can be incorporated therein.

The transmission path 122 can include a wireless path that operates in accordance with a wireless local area network protocol such as a cellular data protocol, an 802.11 protocol, a WIMAX protocol, a Bluetooth protocol, etc. Further, the transmission path can include a wired path that operates in accordance with a wired protocol such as a Universal Serial Bus protocol, an Ethernet protocol, Internet protocol, or other high speed protocol.

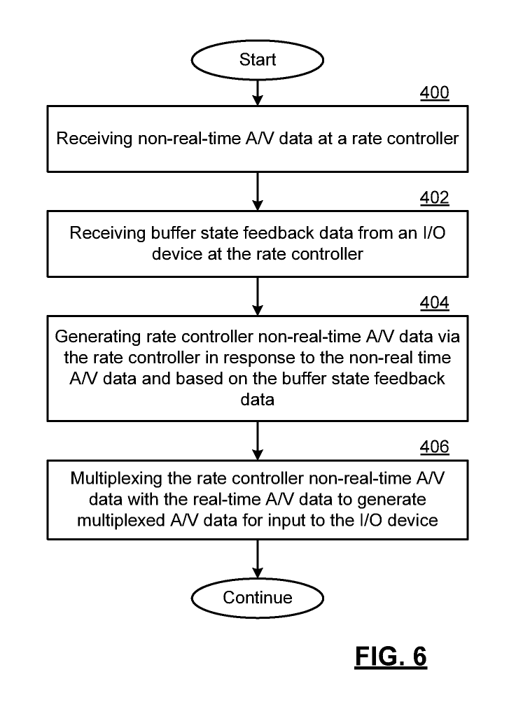

FIG. 6 presents a flowchart representation of a method in accordance with an embodiment of the present invention. In particular a method is presented that includes one or more function and features described in conjunction with FIGS. 1-6. In step 400, non-real time audio/video (A/V) data is received at a rate controller. In step 402, buffer state feedback data is received from an input/output (I/O) device at the rate controller. In step 404, rate controlled non-real time A/V data is generated via the rate controller in response to the non-real time audio/video A/V data and based on the buffer state feedback data. In step 406, the rate controlled non-real time A/V data is multiplexed with real-time A/V data to generate multiplexed A/V data for input to the I/O device.

In an embodiment, the I/O device includes a buffer and the buffer state feedback data indicates a fullness of the buffer. Step 404 can include adjusting a rate of the rate controlled non-real time A/V data in response to the buffer state feedback data, lowering a rate of the rate controlled non-real time A/V data when the buffer state feedback indicates the fullness of the buffer is above a fullness threshold and/or lowering a rate of the rate controlled non-real time A/V data to zero when the buffer state feedback indicates the fullness of the buffer is above a fullness threshold. The non-real time A/V data can include a plurality of non-real time A/V programs. The real time A/V data can include a plurality of real time A/V programs.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a device such as a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A video processing device comprising:
a rate controller coupled to receive non-real time audio/video (A/V) data and buffer state feedback data from an input/output (I/O) device that generates rate controlled non-real time A/V data in response thereto; and
a multiplexor, coupled to the rate controller, that multiplexes the rate controlled non-real time A/V data with real-time A/V data to generates multiplexed A/V data for input to the I/O device.

2. The video processing device of claim 1 wherein the I/O device includes a buffer and the buffer state feedback data indicates a fullness of the buffer.

3. The video processing device of claim 1 wherein the rate controller adjusts a rate of the rate controlled non-real time A/V data in response to the buffer state feedback data.

4. The video processing device of claim 1 wherein the I/O device includes a buffer and the buffer state feedback data indicates a fullness of the buffer and wherein the rate controller lowers a rate of the rate controlled non-real time A/V data when the buffer state feedback indicates the fullness of the buffer is above a fullness threshold.

5. The video processing device of claim 1 wherein the I/O device includes a buffer and the buffer state feedback data indicates a fullness of the buffer and wherein the rate controller lowers a rate of the rate controlled non-real time A/V data to zero when the buffer state feedback indicates the fullness of the buffer is above a fullness threshold.

6. The video processing device of claim 1 wherein the non-real time A/V data includes a plurality of non-real time A/V programs.

7. The video processing device of claim 1 wherein the real time A/V data includes a plurality of real time A/V programs.

8. A method comprising:
receiving non-real time audio/video (A/V) data at a rate controller;
receiving buffer state feedback data from an input/output (I/O) device at the rate controller;
generating rate controlled non-real time A/V data via the rate controller in response to the non-real time audio/video A/V data and based on the buffer state feedback data; and
multiplexing the rate controlled non-real time A/V data with real-time A/V data to generate multiplexed A/V data for input to the I/O device.

9. The method of claim 8 wherein the I/O device includes a buffer and the buffer state feedback data indicates a fullness of the buffer.

10. The method of claim 8 wherein generating the rate controlled non-real time A/V data includes adjusting a rate of the rate controlled non-real time A/V data in response to the buffer state feedback data.

11. The method of claim 8 wherein the I/O device includes a buffer and the buffer state feedback data indicates a fullness of the buffer and wherein generating the rate controlled non-real time A/V data includes lowering a rate of the rate controlled non-real time A/V data when the buffer state feedback indicates the fullness of the buffer is above a fullness threshold.

12. The method of claim 8 wherein the I/O device includes a buffer and the buffer state feedback data indicates a fullness of the buffer and wherein generating the rate controlled non-real time A/V data includes lowering a rate of the rate controlled non-real time A/V data to zero when the buffer state feedback indicates the fullness of the buffer is above a fullness threshold.

13. The method of claim 8 wherein the non-real time A/V data includes a plurality of non-real time A/V programs.

14. The method of claim 8 wherein the real time A/V data includes a plurality of real time A/V programs.
